(19) United States
(12) Patent Application Publication
(10) Pub. No.: US 2002/0169683 A1
(43) Pub. Date: Nov. 14, 2002

(54) Method for automated shopping

(76) Inventor: Neil Parpart, Boise, ID (US)

Correspondence Address: HEWLETT-PARKARD COMPANY, Intellectual Property Administration, P.O. Box 272400, Fort Collins, CO, 80527-2400, US

(21) Appl. No.: 09/855,210

(22) Filed: May 14, 2001

(51) Int. Cl. G06F 17/60

(52) U.S. Cl. 705/26

(57) ABSTRACT

A method for automated shopping has steps of scanning a user ID with a handheld wand, scanning a vendor ID with the wand, and scanning a product ID with the wand. The wand is then placed in a cradle module for connection with an order center over a data network, with the scanned vendor ID, product ID, and user ID transmitted over the data network to the order center. Shopping is thereby accomplished with minimal effort on the shopper's part, and with fast order placement.

### FIELD OF THE INVENTION

The present invention relates to automated shopping methods. More particularly, the present invention relates to methods for selection of items from a catalog and for ordering over a data network.

### BACKGROUND OF THE INVENTION

Certain events through history have brought with them marked advances in shopping technology. For example, around the beginning of the 19^{th} century widespread catalog shopping revolutionalized retail shopping. For the first time rural and other shoppers that did not have access to stores with large inventories had a wide selection of goods that they could order through the mail. Since then, catalog shopping has remained a popular shopping option in our world economy.

Through the years, catalog shopping has changed as technological advances have arrived. Innovations have generally centered on speeding the order processing time. As a relatively recent example, catalog shoppers today can quickly order their selections over the phone via toll free reverse charge phone service from virtually anywhere in the world. This has greatly sped the ordering process over prior art methods that generally comprised mailing of orders. Phone orders are processed by a representative at a “call center” which may be a part of the catalog vendor or may be a service that the vendor pays an order processing fee to.

Even given the technological advances made in the art, however, problems remain heretofore unresolved. As an example, the cost of the reverse charge phone service may be considerable for the vendor. Often catalogs are distributed on a national or even an international basis, with the result that reverse charge phone charges are high. Further, the cost of either paying for an outside contractor call center or an internal call center is significant. Finally, there remains a processing time delay in the processing of the order by the call center personnel, who must take the order, enter it into an order entry system, and advance it.

Additionally, there is constant effort in the art to reduce barriers to customer purchase. That is, there is a continuing interest in making the ordering process as easy and fast as possible for customers to take advantage of so called “impulse buying”. It has been discovered that the quicker and easier a customer can place an order, the more likely they are to do so. Current methods for catalog sales that require a customer to pick up a phone, dial a number, wait for a service representative, and then orally enter sometimes detailed item and shipping information have a relatively high barrier to customer ordering, thereby discouraging impulse buying. Ordering by mail has even higher barriers to ordering.

The recent past has seen attempts to address some of these problems in the art through on-line shopping methods. In particular, vendors may provide for order entry over the internet with shopping selections displayed on world wide web pages. While these methods generally offer fast order placement for users, they have several shortcomings. Users are required to own relatively expensive computer equipment, to have a level of computer expertise, and to subscribe to internet service providers. These factors, among others, have resulted in the limited success of on-line shopping methods as known heretofore.

These and other problems in the art thus remain unresolved, and there is therefore a need for improved automated catalog shopping methods.

### SUMMARY OF THE INVENTION

The present invention generally comprises an improved method for automated shopping. The method generally comprises the steps of scanning user, vendor and product information into a handheld scanning means where the data is stored in a transaction file, connecting the scanning means with an order center over a data network, and transmitting the transaction file over the data network to the order center for processing.

In a preferred embodiment of the method of the invention, the scanning means comprises a handheld wand with optical reading means, and the step of connecting the wand to the order center over the data network comprises placing the wand in a cradle module connected to the data network. The transaction file storing the user, product and vendor data is then transmitted to the order center for processing. Preferably, a confirmation signal indicating receipt of the order is transmitted from the order center back to the wand. The confirmation signal may be received by a preferred peripheral device such as a printer or a monitor attached to the cradle, or may be received by a confirmation indicator on the wand or cradle itself.

The various embodiments of the improved method of the invention thereby solve many of the heretofore unresolved problems in the art. A method for automated shopping having a very low order entry barrier is achieved. All that is required of users is to simply scan in information with the scanning means; there are no phone calls to place or orders to mail. Further, the order is in the form of a transaction file that may be readily processed in an orderly fashion with very little human interaction required. This greatly reduces the cost of and the time required for order processing.

The above brief description sets forth rather broadly the more important features of the present disclosure so that the detailed description that follows may be better understood, and so that the present contributions to the art may be better appreciated. There are, of course, additional features of the disclosure that will be described hereinafter which will further describe the subject matter of the invention. In this respect, before explaining an embodiment of the disclosure in detail, it is to be understood that the disclosure is not limited in its application to the details of the construction and the arrangements set forth in the following description or illustrated in the drawings. The present invention is capable of other embodiments and of being practiced and carried out in various ways, as will be appreciated by those skilled in the art. Also, it is to be understood that the phraseology and terminology employed herein are for description and not limitation.

### BRIEF DESCRIPTION OF THE DRAWINGS

FIG. 1 is a perspective view of an embodiment of the wand provided through a step of the method of the invention.

FIG. 2 is a perspective view of the wand of FIG. 1 placed in a cradle module provided through a step of an embodiment of the method of the invention.

FIG. 3 is a top plan view of the cradle of FIG. 2.

FIG. 4 is a network schematic useful in illustrating the practice of an embodiment of the method of the invention.

FIG. 5 is a perspective view of the wand of FIG. 1 scanning a vendor identity code.

FIG. 6 is a perspective view of the wand of FIG. 1 scanning a product code from the catalog of FIG. 5.

FIG. 7 is a schematic of a data network configuration useful in explaining an embodiment of the method of the invention.

FIG. 8 is a flow chart illustrating a subset of steps of an embodiment of the method of the invention.

### DETAILED DESCRIPTION

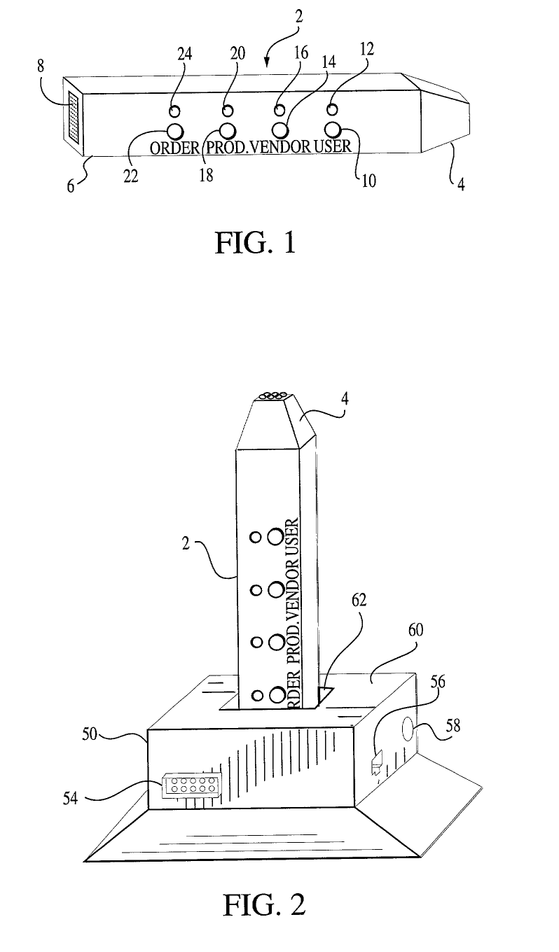

Turning now to the drawings, FIG. 1 is a perspective view of a preferred scanning means provided through a step of the method of the invention. In particular, a handheld wand 2 comprises a first 4 and a second 6 distal end, with optical reading means contained in the first distal end 4 and a first connector 8 at the second distal end 6. The optical reading means contained in the first distal end 4 may comprise a multiplicity of different particular configurations as may be known in the art, with a preferred configuration comprising means for emitting light rays, receiving reflections resultant from the emitted light rays, and discerning images or characters from the reflections. These optical reading means are contained within the wand 2 near the first distal end 4, which may have a glass or other translucent member at the distal end 4.

The preferred wand 2 further comprises a number of switching means and indicator means along its length. In particular, a plurality of operable buttons and indicator lights comprising a user mode switch 10, a user mode indicator light 12, a vendor mode switch 14, a vendor mode indicator light 16, a product mode switch 18, a product mode indicator light 20, an order mode switch 22, and an order mode indicator light 24.

It will be appreciated that the wand 2 of the invention may comprise any of a multiplicity of switching and indicator means that differ from the buttons and indicator lights illustrated in FIG. 1. By way of example and not limitation, alternate switching and indicator means may comprise other mechanical switches such as slide or cradle switches, or may comprise a display screen with controls for scrolling through information and selecting desired of the information. The controls may comprise touchable portions of the display screen, depressible buttons, or the like. Indicator means may also be comprised on the display screen, which may utilize liquid crystal display (“LCD”) technology.

The wand 2 further comprises a memory module in which at least a transaction file is stored. The memory module may comprise any of a number of media that are useful for storing data, with preferred examples comprising magnetic media, optical media, flash memory chips, VRAM chips, and the like.

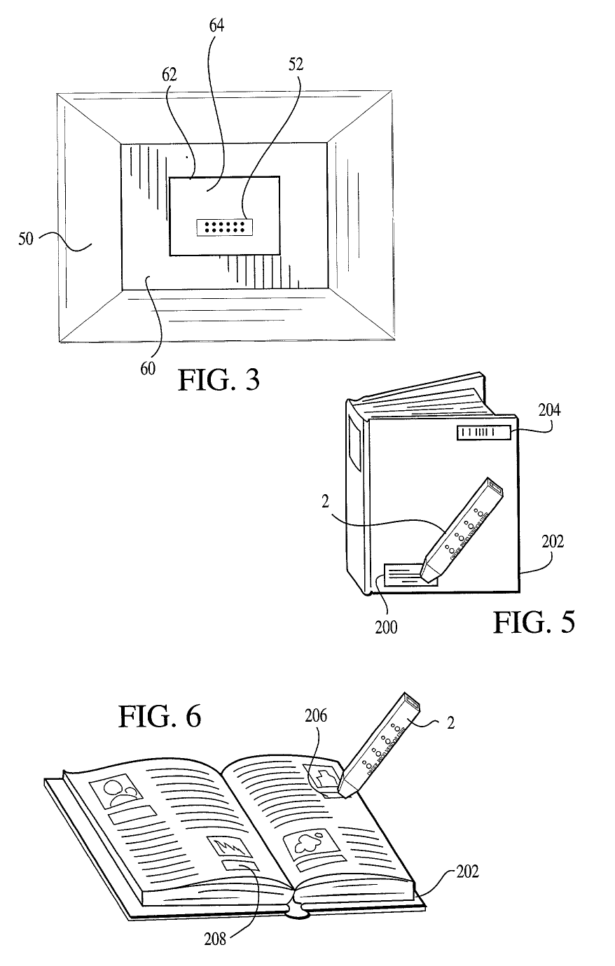

FIG. 2 is a perspective view of the wand 2 removably placed in a cradle module 50 that is provided through an additional step of the preferred embodiment of the method of the invention, and which is shown in top plan view in FIG. 3. The preferred cradle 50 comprises a second connector 52 for mating with wand first connector 8, a peripheral connector 54 for connection to a peripheral device, a data network connector 56 for connection to a data network, and a power connector 58 for connection to a power source.

As illustrated in FIGS. 2-3, the preferred cradle 50 further comprises a top side 60 with a recess 62 therein. The second connector 52 sits on the floor 64 of the recess 62, whereby the wand 2 may be operably connected to the cradle 50 by inserting the wand second distal end 8 downward into the cradle recess 62 and connecting the wand's first connector 8 with the cradle's cooperating second connector 52, with FIG. 2 illustrating the wand 2 so inserted.

The wand first connector 8 and the cooperating cradle second connector 52 have been illustrated as generally comprising cooperating male and female pin connectors. It will be appreciated that a multiplicity of other connector means may be used within the method of the invention. Indeed, as used herein, the terms “connector means” and “connector” are intended to refer to any means suitable for transferring data. Examples of “connectors” or “connection means” as used herein include, but are not limited to, wireless connectors such as optical, radio, and cellular connectors in addition to connectors that require physical contact.

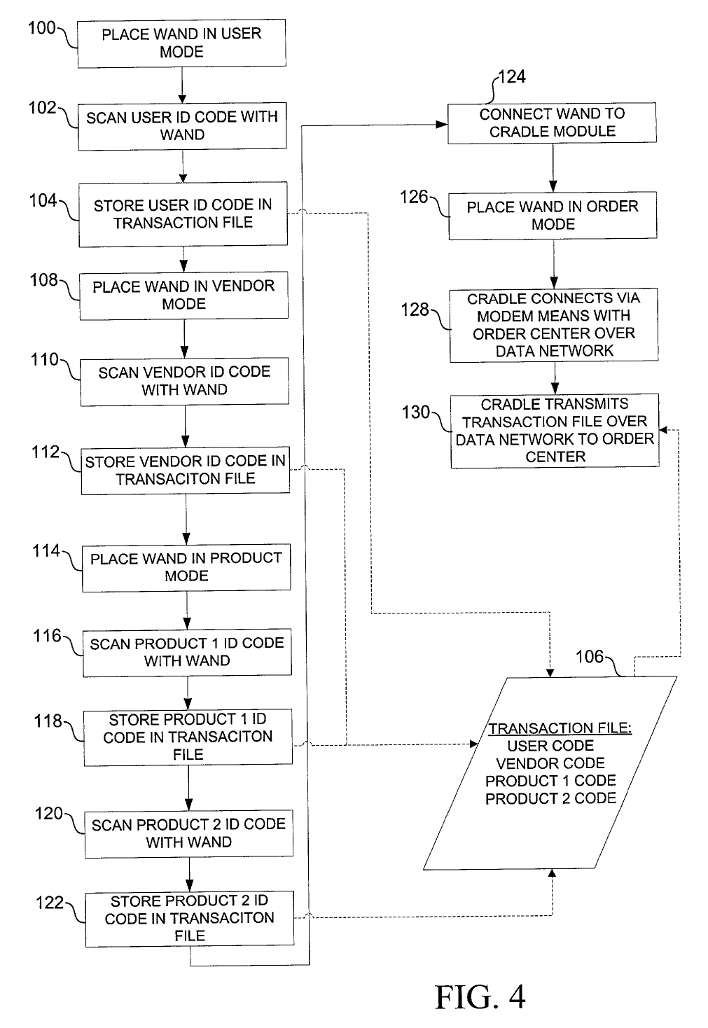

Through the steps of a preferred embodiment of the invention, the wand 2 may be used to select items for purchase from a catalog and then to place an order for the items over a data network. The flow chart of FIG. 4 will be useful in illustrating a sub-set of steps of a preferred embodiment of the method of the invention through which the wand 2 can be used to purchase items from a catalog. With reference to FIGS. 1 and 4, the wand 2 is placed in a “user mode” by activating the user mode switch 10 (block 100). The user switch may be “activated” by way of example by pressing a depressible button, physically contacting a touch screen, or the like. Confirmation of entry into user mode status occurs through lighting of the user mode indicator light 12. Once in user mode, the wand 2 is used to scan a machine-readable unique user identity code with its optical reading means (block 102).

The unique user identity code may be obtained from any of a number of sources. A preferred machine-readable user code source is a mailing or other identity label on a catalog. Accordingly, FIG. 5 is a perspective view of the wand 2 being used to scan a user code from a user mailing label 200 from a catalog 202. It will be appreciated that the method of the invention may be practiced with any of a multiplicity of formats for unique identity codes, so long as they are machine-readable. It will also be noted that as used herein, the term “machine-readable” is intended to refer to an ability to be interpreted by a machine. With these considerations in mind, examples of machine-readable user codes capable of use within the method of the invention will include, but are not limited to, alphanumeric characters, bar codes, coded images, coded reflection images, and the like.

It has been discovered that a convenient means within the method of the invention for providing a machine-readable user code is a catalog mailing label 200 as illustrated in FIG. 5. The mailing label 200 may be required for mailing of the catalog to the user, so its use for providing a user code as well provides for efficiency (i.e., no second labeling required). Further, the preferred mailing label 200 comprises address data in addition to a user name, and may also comprise additional personalized customer data that may be encoded in a bar code or the like.

This personalized data can be of use within a preferred embodiment of the invention for eventual shipping of a selected product, and for marketing purposes. It will thus be appreciated that as used herein, the user identity code or user code may comprise data in addition to a user name, with examples being a user code that comprises address data or a user code that comprises customer profile data. An additional example of a source for obtaining a user code within the method of the invention comprises a credit card. Scanning of a credit card may also advantageously provide billing account information in addition to a user name.

With reference once again to the FIGS. 4 and 1, the scanned user code is stored in a transaction file 106 within the wand 2 memory module (block 104). To enter vendor information, the wand 2 is first placed into a “vendor mode” (block 108). This is accomplished by activating the vendor switch 14 of FIG. 1, with a confirmation of the wand 2 being in a vendor mode provided through a lighting of the vendor mode indicator light 16. Once placed in vendor mode, the wand 2 may be used to read a machine-readable vendor identity code (block 110). With reference to FIG. 5, a machine-readable vendor identity code may comprise a catalog label 204 on the catalog 202 cover.

As discussed above with reference to the machine-readable user code, it will be appreciated that the vendor identity code may be comprised of any of a variety of machine-readable means in addition to the catalog label 204. By way of example, the vendor identity code could comprise the catalog name from the catalog cover, or a vendor identity code could be provided on the mailing label 200. Further, it will be appreciated that the method of the invention does not require the vendor identity code to be contained on the catalog cover or for that matter anywhere in the catalog 202 itself. Once read, the vendor identity code is stored in the transaction file 106 (block 112).

To select a product from the catalog 202, the wand 2 is preferably first placed into a product mode (block 114). This may be accomplished by activating the product mode switch 18, with confirmation of entry to product mode provided by illumination of the product mode indicator light 20. Once in its product mode, the wand 2 may be used to select the products from the catalog 202 that are desired for purchase (block 116). By way of illustration, FIG. 6 shows the wand 2 scanning a machine-readable product code 206 associated with a product from the catalog 202. The product code 206 may comprise any of a multiplicity of machine-readable means, as generally discussed herein above with reference to user and vendor identity codes.

A preferred product code means comprises an alphanumeric product code that may be used to identify the product for purposes other than the method of the invention. That is, an alphanumeric product code likely already exists for purposes of ordering the product via phone or mail. It has been discovered that use of this existing product code within the method of the invention achieves efficiency.

Once read, the product code is stored in the transaction file 106 (block 118). It will be appreciated that once placed in a product mode, the wand 2 may be used to choose a plurality or even a multiplicity of items for purchase. Accordingly, FIG. 4 describes the step of scanning a second product code (node 120). Referencing FIG. 6 once again by way of illustration, the wand 2 could be used to scan the product code 208 from the catalog 202 corresponding to a second product desired for purchase. Once scanned, the product code from the second product is also stored in the transaction file 106 (block 122 of FIG. 4). The transaction file 106 now contains the user code, the vendor identity code, and the two product codes corresponding to the products desired for purchase.

It will be appreciated that a plurality of products may be selected from a plurality of catalogs within a single transaction file. That is, a first vendor identity code could be scanned by the wand 2, with a plurality of products selected that correspond to that vendor by scanning in their respective product identity codes. A second vendor catalog could then be selected by scanning in that second catalog's vendor identity code. One or more products could then be selected from that second catalog by scanning in their respective identity codes. All of this data would then be stored in the transaction file, so that the transaction file would contain a user identity code, a first vendor identity code, a list of products selected from the first catalog, a second vendor identity code, and a list of products selected from the second catalog. The wand 2 may of course alternatively create two separate transaction files.

Additionally, it will be appreciated that a single catalog may comprise products available from a plurality of different vendors. As an example, a single catalog for automotive products may list individual products such as tires available from a first vendor and seat covers available from a second vendor. Under these circumstances, the catalog portion that lists the tires available from the first vendor will have a first vendor code for scanning by the wand 2 corresponding to selection of tire products, and the catalog portion that lists the seat covers will have a second vendor code for scanning corresponding to selection of any of those products.

It will likewise be appreciated that the term “catalog” as used herein is intended to broadly refer to any media offering a listing of products available for purchase. By way of example, a “catalog” as used herein is not intended to be limited to a paper media. Instead, a catalog my comprise a television transmission, a world wide web page, or other media. In this sense, the method of the invention could be practice by scanning product and vendor codes from on-screen displays.

Regardless of the particular catalog format, once all products desired for purchase from one or more of the catalogs have been scanned and their corresponding product codes stored in the transaction file 106, additional steps of the method of the invention comprise placing the order. This is preferably accomplished by placing the wand 2 in the cradle module 50 (block 124). With reference to FIGS. 1-3, placing the wand 2 in the cradle module 50 results in operable connection of the first connector 8 near the wand second distal end 6 to the cradle second connector 52 on the floor 64 of the cradle recess 62. It will be appreciated that the method of the invention is not limited to the particular steps of “connection” discussed or illustrated herein; indeed a multiplicity of connection variations are possible. By way of example and not limitation, a wireless connection may be used between the wand 2 and the cradle 50

To transmit the transaction file 106 to the order center, the wand 2 may be placed in “order mode”, which may be accomplished by activating the wand order mode switch 22 of FIG. 1 (block 126 of FIG. 4). The order mode indicator light 24 provides confirmation of entry into order mode. Placing the wand 2 into its order mode indicates to the cradle 50 that an order is to be placed. Accordingly, the cradle 50 connects over the data network with an order center (block 128). As ordering will occur with the wand 2 connected to the cradle module 50, the order switch means and indicator means may alternatively be located on the cradle module 50.

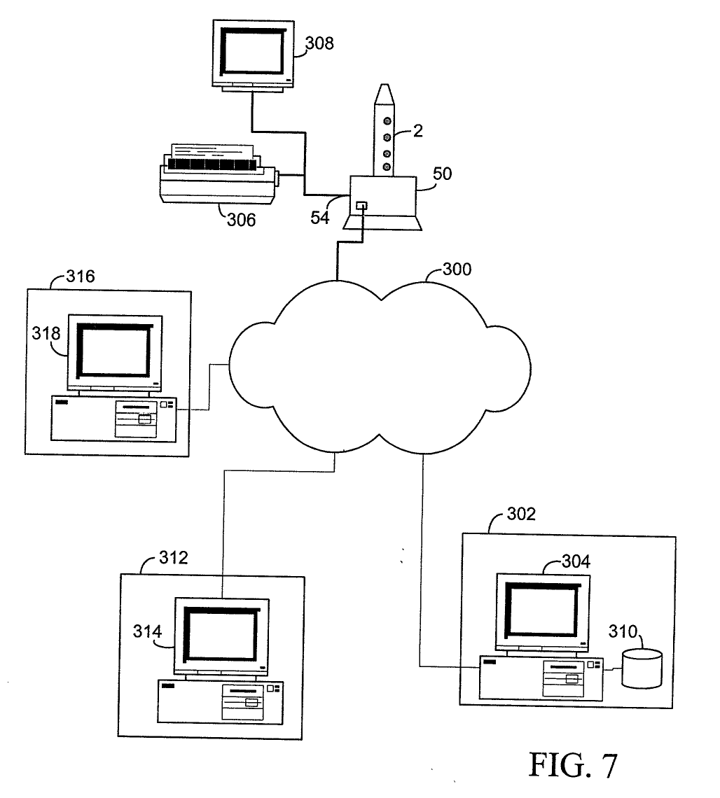

These and subsequent steps of the method of the invention may be better understood with reference to the network schematic of FIG. 7, which generally illustrates the wand 2 and the cradle 50 connected to a data network 300, which is in turn connected to an order center 302 (illustrated by a box) that has at least a computer device 304 therein. It will be appreciated that the term “data network” as used herein is intended to refer to any group of computer devices connected to one another to facilitate the transfer of data therebetween. By way of example and not limitation, the data network 300 may comprise a wire network such as the PSTN or a commercial data network, a fiber optic network, a wireless network, or the like. In a preferred embodiment of the method of the invention, the data network 300 comprises the Internet. The Internet is preferred because of its widespread availability and relative low cost of use.

The cradle 50 connects to the order center 302 over the data network 300 through any of a number of known methods. As a preferred example, the cradle 50 will comprise a communications module for operative connection to the data network 300. A preferred communications module comprises a modem for using the PSTN to communicate data. In this preferred example, the wand 2 or cradle 50 may have a reverse charge “800” number stored therein for dialing by the modem to reach an order center point of presence (“POP”). Alternatively, the POP reached through dialing of the 800 number could “look” at the incoming call for an origination number and determine a local number for the cradle 50 to dial for access to a second POP located local to the cradle 50. This desired local number would then be transmitted to the cradle 50 for future use to reduce calling costs.

With reference to FIGS. 4 and 7, once connected to the data network 300 the transaction file 106 is transmitted from the wand 2 memory module over the data network 300 to the order center 302 (block 130). The order center 302 may be identified for addressing purposes by an address such as a URL address. This address may be stored in the wand 2 memory module, the cradle 50 communications module, or may be obtained by scanning an address from the catalog 202 of FIGS. 5-6. In this respect, it will be understood that the vendor identity code may comprise more than a single data entry.

That is, in an embodiment of the method of the invention the step of reading the machine-readable vendor identity code with the wand 2 may comprise reading a plurality of machine-readable codes, all of which are referred to herein as the vendor identity code. It will be likewise be appreciated that embodiments of the method of the invention may comprise user identity codes and the product identity codes may also each comprise a plurality of data items for entry. As an example, a user identity code may comprise billing information and address information in addition to a user name, which may require scanning of a user mailing address in addition to scanning of a credit card.

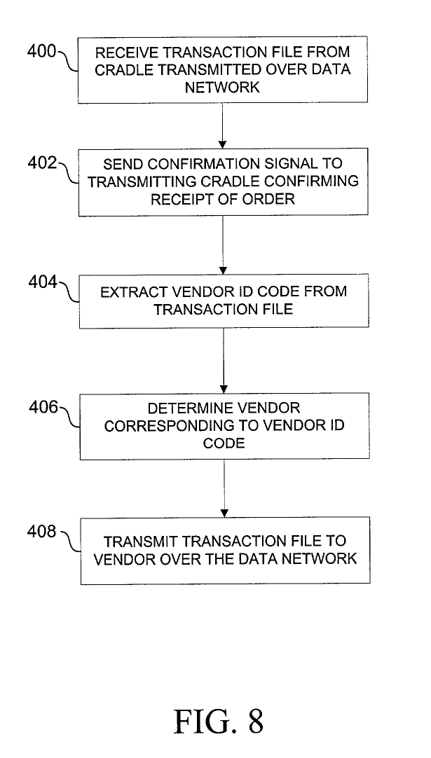

Once received at the order center 302, the transaction file 106 is processed for filling. An additional preferred sub-set of steps of an embodiment of the invention that generally describes the processing of the order by the order center 302 of FIG. 7 are described in the flow chart of FIG. 8. The transaction file 106 will first be received at the order center 302 by the computer device 304 (block 400). After successful receipt of the transaction file 106, a confirmation signal is transmitted from the computer device 304 over the data network 300 back to the cradle 50 (block 402).

The receipt of the confirmation signal may occur by any of a plurality of additional steps of embodiments of the method of the invention. A preferred set of steps comprises providing a peripheral device such as a printer 306 or a monitor 308 connected to the cradle peripheral connector 54. In particular, a printer 306 is most preferred as a “hard copy” of the transaction will advantageously be made available for record keeping. The preferred confirmation signal transmitted through this embodiment of the invention comprises at least confirmation of the items ordered, a user identity and shipping address, the vendor the items were ordered from, and the date the order was placed. More preferably, the confirmation signal further comprises estimated delivery dates and shipping costs.

Other information may of course be provided for display on a peripheral device such as printer 306 in addition to order confirmation. By way of example and not limitation, additional steps of the method of the invention may comprise requesting a quotation for delivery time or delivery cost before placing or confirming an order. By way of further example, it may provide commercial advantage to the vendor to transmit advertisements for display by the peripheral device. In particular, customized advertisements made to the user in response to their purchase may be made. Should a customer purchase a first item, for example, the vendor may offer the user a discount on a second identical item or a second complementary item. In this manner it will be appreciated that the present invention allows for innovative marketing opportunities through communications over the peripheral device.

In still additional embodiments of the method of the invention, the method will further comprise steps of providing means for receiving and displaying the confirmation signal that may comprise sub-components of the wand 2 or of the cradle 50. As an example, either or both of the wand 2 and the cradle 50 may comprise a display screen such as an LCD screen for displaying information such as the receipt of the confirmation signal. As an additional example, either the wand 2 or the cradle 50 may comprise a display indicator light for indicating that a confirmation signal has been received.

In yet an additional embodiment of the invention, the order center 302 does not represent a vendor, but instead represents a clearing-house type entity for processing orders and forwarding to vendors for filling. It has been discovered that many vendors do not have the resources to maintain a data network order center such as generally illustrated at 302. For these vendors, the preferred method of the invention will be of particular utility in they may contract out for this service to a clearinghouse type entity as described with reference to the order center 302.

In this invention embodiment the processing of the transaction file 106 will of course require determining what particular vendor 312 or 316 orders are destined for. This can be accomplished at the order center 302 by first extracting the vendor identity code(s) from the transaction file (block 404 of FIG. 8). This may occur for example by reference to a database 310 that cross-references vendor identity codes with vendors (block 406 of FIG. 8). The vendor 312 or 316 will preferably be identified with a data network accessible address. This address will then be used to address the transaction file, or relevant portions thereof, to the particular vendor 312. Finally, the transaction file or relevant portion thereof will be transmitted over the data network 300 to the desired vendor 312 or 316, preferably to a computer device 314 or 318 at the respective vendor (block 408 of FIG. 8).

Alternatively, the method of the invention may comprise forwarding the order from the order center 302 to the vendor 312 or 316 by means other than the data network 300. This particular embodiment of the invention may be of particular utility for use by smaller or less sophisticated vendors that do not have resources to support an on-line order center of their own. Some of these vendors may not even have resources required for an operable connection to a data network, or for internal processing of orders received from the order center 302 over the data network 300. For these vendors, additional steps of this invention embodiment may comprise forwarding orders via mediums other than the data network 300, such as via phone, mail, or facsimile transmission.

It will be also appreciated that some embodiments of the method of the invention may comprise additional steps of order processing to those described in FIG. 8. As an example, the order center 302 of FIG. 7 may receive a plurality of transaction files destined for a particular vendor within a single day. An additional step of order processing may comprise assembling this plurality of individual transaction files into a single daily order file that is then transmitted to the particular vendor.

In addition, a single transaction file may contain product purchase data corresponding to a plurality of different vendors. Under these circumstances additional order processing steps will comprise extracting the order data for each particular vendor, and forwarding this data to the corresponding vendor. Referring to FIG. 7 by way of example, a single transaction file may be received with products desired for purchase from the first vendor 312 and from the second vendor 316. Through an embodiment of the invention, the items for purchase from the vendor 312 may be extracted from the transaction file along with the first vendor 312 identity code. Data comprising the items for purchase and the user identity code will then be transmitted over the data network 300 to the first vendor 312. Likewise, the items desired for purchase from the second vendor 316 along with the second vendor identification code will be extracted from the transaction file and transmitted over the data network 300 to the second vendor 316 along with the purchaser's user identity code.

These embodiments of the invention generally comprise methods for using a clearinghouse-like order center 302 of FIG. 7 for processing orders that are then forwarded to a vendor 312 or 316 for ultimate filling. It will be appreciated, however, that the method of the invention as claimed is not limited to such a configuration. Indeed, the method of the invention will likewise be of utility for practice with transaction files being sent directly to a vendor, in which case the order center 302 may be considered to be an ultimate vendor. Further, the order center 302 may comprise a vendor's order center that receives and processes orders and then transmits instructions over the data network to one or more of the vendor's warehouses for shipping of goods. With this consideration in mind it will be appreciated that facilities 316 and 312 of FIG. 7 may represent warehouses for the same vendor that maintains call center 302.

Likewise, it will be understood that the invention is not limited to transmission of the transaction file 106 over the data network 300 to a single order center 302. In other embodiments of the invention the vendor identity code scanned by the wand 2 may further comprise a unique URL address for the vendor. The transaction file 106 will then be transmitted directly to this particular vendor over the data network. By way of example with reference to FIG. 7, a transaction file may be transmitted directly from the wand 2 to the vendor 312. It will thus be appreciated that use of the term “order center” herein is intended only to refer to an entity having the capability to receive orders, and is not intended to be limited in any manner to any particular business organization beyond that. That is, a vendor may comprise an order center as used herein.

Still an additional embodiment of the method of the invention will comprise steps to determine the status of pending orders. In this method embodiment, the wand 2 or cradle 50 may have a status switch means which when activated transmit an order status prompt over the data network 300 to the order center 302 along with a user identity code. The order center 302 may respond to the status prompt by transmitting to the peripheral printer 306 and/or the peripheral monitor 308 information regarding all open orders associated with the user identity code. Information may comprise an order received date, a shipping date, a list of items on back order, and the like.

The method of the invention may also comprise embodiments that combine the cradle module 50 with one or more peripheral devices. By way of example, the cradle module 50 may be combined with the peripheral printer 306 and/or the peripheral monitor 308. That is, a single device may combine the functionality of the cradle module with a printer and/or a monitor. This may provide for an advantageous commercial embodiment of the invention, as a user will not be required to purchase and connect separate devices, and cost savings may be achieved through manufacture of a single, low cost “dumb” device that provides only the limited printer or monitor functionality required for practice of the invention.

Indeed, it will be appreciated that an advantage of the various embodiments of the invention comprises allowing users to participate in “online” shopping without purchase of expensive computer systems, without requiring computer system skills, and without requiring subscription to internet service providers. The wand 2 and cradle module 50 of the invention are relatively simple and “dumb” devices, and may be provided at a cost that is likely an order of magnitude below that of a computer system. Further, a vendor may wish to provide the wand 2 and cradle module 50 at no charge or at a greatly reduced charge to users to encourage increased sales.

Additional embodiments of the present invention comprise computer program products. In particular, the present invention further comprises a computer program product having computer executable instructions stored in a computer readable medium for causing the various steps of the method embodiments as described herein to be executed. The computer readable medium preferably comprises any of several computer readable memory devices as are generally known in the art, with examples comprising magnetic media such as disks; optical media such as disks; circuitry embedded on a circuit board, chip or chipset; RAM, VRAM, or flash RAM devices; and the like. In a preferred computer program product embodiment, the computer readable medium with executable instructions thereon comprises a portion of the memory module within the wand 2, and when executed causes the wand 2 to execute the steps of the invention.

In particular, this preferred computer program embodiment comprises stored executable instructions that when executed cause the wand 2 to enter into a vendor mode upon activation of the vendor mode switch means 14 on the wand 2, to read a machine readable vendor code 204 from the catalog 202 with the wand 2 while in said vendor mode, and to store the vendor code 204 in a transaction file 106 in the wand memory module. The instructions likewise cause the wand 2 to enter into a user mode upon activation of the user mode switch means 10, to read a machine readable user identity code 200 from the catalog 202 while in the user mode, and to store the user identity code 200 in the transaction file 106. The instructions further cause the wand 2 to enter into a product mode upon activation of the product mode switch means 18, to read a machine readable product identity code 206 from the catalog 202 while in the product mode, and to store the product identity code in the transaction file 106.

After entry of product, user, and vendor information, the user may wish to place his order. Accordingly, the computer instructions cause the wand 2 to enter into an order mode upon activation of the order mode switch 22, to connect to the data network 300 through the cradle module 50, and to transmit the transaction file 106 over the data network 300 to the order center 302 while in order mode. The instructions likewise cause the wand 2 to accept a confirmation signal transmitted over the data network 300 sent from the order center 302, and to output the confirmation signal over the peripheral printer 306 and/or the peripheral monitor 308 attached to the cradle module 50. The confirmation signal preferably comprises shipping cost data and delivery time data.

It will be appreciated that in addition to the preferred wand memory module location, the computer instructions may be partially stored in a memory module within the cradle 50, or within another device that is operably connected to the data network 300.

The method and computer program product of the invention thereby solve many of the heretofore-unresolved problems in the art in a novel and elegant fashion. Practice of the invention allows for catalogue shopping with a level of ease of use and efficiency never before possible. Users may place orders from a catalog without mailing or telephoning a vendor. Also, users are not required to purchase computers or subscribe to internet service providers, but instead may obtain relatively inexpensive wands and cradle modules. Vendors are able to receive and process orders without costly telephone bills and telephone operators, and orders are received by the vendor in a digital format so that no order entry efforts or costs are required.

Although a number of embodiments of the method of the invention have been discussed and explained herein, it will be appreciated that the method of the invention as claimed is not limited to these embodiments. Indeed, those knowledgeable in the art will appreciate that many additional methods for practicing the invention within the scope of the claims are possible. As an example, the various embodiments of the method of the invention have been herein described comprising steps of scanning at least three generally separate data fields for building a transaction file: a user identity code, a vendor identity code, and a product identity code. It will be understood that the method as claimed does not require that this data be present in three separate fields. It is within the scope of the method of the invention as claimed for all of the required transaction file data to be obtained by scanning only two or even a single data field.

That is, all of the required data may be present within a single field. A product catalog may be mailed or broadcast to a particular user with a plurality of products listed therein. Each of the products may have an individual product code that contains vendor identification code data as well as product identification code data. In this case, a user would not be required to scan a vendor identity code, but instead could obtain all the data required by scanning a user identity code and then scanning product code data from products desired for purchase. Further, the catalog could include personalized product data containing user identification data within the product codes corresponding to the individual user the catalog was mailed or broadcast to, thereby allowing for all required data to be obtained by scanning the single product code.

In addition, it will be understood that the particular sequence of information scanning is not important to the method, and that the method and computer program product as claimed are not limited to any particular sequence. That is, the present invention is not limited to any sequence of scanning of the user identity code, the vendor identity code, and the product identity code. It is important to the method of the invention, however, that all three codes be scanned at some point, and that information from all three fields is present in a transaction file.

The various embodiments of the method described herein have also made reference to scanning means that are optical in nature. Other scanning means suitable for use in the method of the invention include, but are not limited to, magnetic scanning means as are generally known. Use of these magnetic scanning means would of course require user identity codes, vendor codes, and product codes to be in magnetically readable formats. Credit and charge cards having magnetic information strips thereon may provide convenient media in this embodiment of the method of the invention for obtaining user and vendor information.

The advantages of the disclosed invention are thus attained in an economical, practical, and facile manner. While preferred embodiments and example configurations have been shown and described, it is to be understood that various further modifications and additional configurations will be apparent to those skilled in the art. It is intended that the specific embodiments and configurations herein disclosed are illustrative of the preferred and best modes for practicing the invention, and should not be interpreted as limitations on the scope of the invention as defined by the appended claims.

Various features of the invention are set forth in the appended claims.

What is claimed is:

1. A method for automated shopping, utilizing an order center connected to a data network, the method comprising the steps of:
reading a machine-readable vendor identity code with a scanning means, said scanning means having a memory element;
storing said vendor identity code in a transaction file stored in said memory element;
reading a machine-readable user identity code with said scanning means;
storing said user identity code in said transaction file;
reading a machine-readable product identity code with said scanning means;
storing said product identity code in said transaction file;
connecting said scanning means to the order center over the data network; and,
transmitting said transaction file over the data network to the order center.

2. A method as defined by claim 1 wherein said scanning means memory element has an order center data network address stored therein, the method further comprising the step of assigning said order center data network address to said transaction file, and wherein said transaction file is transmitted over said data network to said order center network address.

3. A method as defined by claim 1 further comprising the steps of:
receiving said transaction file at the order center;
extracting said vendor identity code from said transaction file;
determining a destination vendor data network address, and
forwarding said transaction file to said destination vendor data network address over the data network.

4. A method as defined by claim 1 wherein said scanning means comprises a handheld wand having two distal ends, a first distal end having optical reader means for reading said vendor identity code, said user identity code, said product identity code, and a second distal end having a connector.

5. A method as defined by claim 1 wherein said step of connecting said scanning means to the order center over the data network further comprises connecting said scanning means to a cradle module, said cradle module connected to the order center over the data network.

6. A method as defined by claim 5 wherein said cradle module having a communication module therein for connecting to the order center over the data network.

7. A method as defined by claim 5 wherein said cradle module further comprises peripheral connection means for connecting to a peripheral device.

8. A method as defined by claim 7 wherein said peripheral device comprises a printer.

9. A method as defined by claim 7 wherein said peripheral device comprises a monitor.

10. A method as defined by claim 7 wherein:
said scanning means comprises an elongated handheld wand having a first connector at a first distal end;
said cradle module having a top side, said top side having a recess, a second connector within said recess for mating with said wand first connector; and,
wherein said step of connecting said scanning means to said cradle module comprises placing said wand first distal end in said cradle module top side recess whereby said wand first connector operably engages said cradle second connector.

11. A method as defined by claim 1 wherein:
said step of reading said machine-readable vendor identity code with said scanning means further comprises placing said scanning means in a vendor mode prior to reading said vendor identity code;
said step of reading a machine-readable user identity code with said scanning means farther comprises placing said scanning means in a user mode prior to reading said user identity code;
said step of reading a machine-readable product identity code with said scanning means further comprises placing said scanning means in a product mode prior to reading said product identity code; and,
said step of transmitting said transaction file over the data network to the order center further comprises placing said scanning means in an order mode prior to transmitting said transaction file.

12. A method as defined by claim 11 wherein said scanning means further comprises:
vendor mode switching means for placing said scanning means in said vendor mode, vendor mode indicator means for indicating said scanning means is in said vendor mode;
user mode switching means for placing said scanning means in said user mode, user mode indicator means for indicating that said scanning means is in said user mode; and,
product mode switching means for placing said scanning means in said product mode, product mode indicator means for indicating that said scanning means is in said product identity mode.

13. A method as defined by claim 12 wherein:
said vendor mode switching means comprise an operable vendor mode button, said vendor mode indicator means comprise a vendor mode indicator light;
said user mode switching means comprise an operable user mode button, said user mode indicator means comprise a user mode indicator light; and,
said product mode switching means comprise an operable product mode button, said product mode indicator means comprise a product mode indicator light.

14. A method as defined by claim 11 wherein said scanning means further comprises order mode switching means for placing said scanning means in said order mode, and wherein said scanning means further comprises order mode indicator means for indicating said scanning means is in said order mode.

15. A method as defined by claim 1 wherein the method further comprises the step of:
receiving a transaction confirmation signal with confirmation indicator means, said confirmation signal being sent from the order center upon receipt of said transaction file.

16. A method as defined by claim 15 wherein said confirmation indicator means comprise a sub-component of said scanning means.

17. A method as defined by claim 15 wherein:
said step of connecting said scanning means to the order center over the data network further comprises connecting said scanning means to a cradle module connected to the data network; and,
wherein said confirmation indicator means comprise a subcomponent of said cradle module.

18. A method as defined by claim 15 wherein:
said step of connecting said scanning means to the order center over the data network further comprises connecting said scanning means to a cradle module connected to the data network; and,
wherein said confirmation indicator means comprise a peripheral device attached to said cradle means.

19. A method as defined by claim 18 wherein said peripheral device comprises a printer.

20. A method as defined by claim 18 wherein said peripheral device comprises a monitor.

21. A method as defined by claim 1 wherein said scanner means further comprises an order status switch means, and wherein the method further comprises the step of:
activating said order status switch means to transmit an order status request over the data network to the order center, said order status request comprising at least said user identity code; and,
receiving an order status reply with a peripheral device attached to the data network.

22. A method for automated shopping from a catalogue, the method utilizing a data network, an order center connected to the data network, a cradle module connected to the data network, and an elongated handheld scanning wand having a memory module, the method comprising the steps of:
placing the wand in a vendor mode by activating a vendor mode switch means on the wand;
reading a machine-readable user vendor identity code from the catalog with optical reading means contained in a first distal end of the wand;
storing said vendor identity code in a transaction file in the wand memory module;
placing the wand in a user mode by activating a user mode switch means on the wand;
reading a machine-readable user identity code with said wand optical reading means;
storing said user identity code in said transaction file;
placing the wand in a product mode by activating a product switching means on the wand;
reading a machine-readable product code from the catalog with said wand optical reading means;
storing said product code in said transaction file;
connecting a first connector on the wand second distal end with a mating second connector on the cradle;
placing said wand in an order mode by switching an order mode switch on the wand;
transmitting said transaction file over the data network to the order center; and,
receiving a confirmation signal with a confirmation indicator sent from the order center over the data network upon receipt of said transaction file.

23. A method as defined by claim 22 wherein the method further comprises the steps of:
extracting said vendor identity code from said transaction file at the order center; and,
transmitting said order over the data network to a vendor corresponding to said vendor identity code.

24. A method as defined by claim 22 wherein said confirmation indicator comprises a printer connected to the cradle module.

25. A method for automated shopping from a catalogue, the method utilizing a data network, an order center connected to the data network, a cradle module connected to the data network, and an elongated wand having two distal ends and a memory module, the method comprising the steps of:
activating vendor mode switch means on the wand to place the wand in a vendor mode;
reading a machine-readable user vendor identity code from the catalog with optical reading means contained in the wand first distal end;
storing said vendor identity code in a transaction file in the wand memory module;
activating user mode switch means on the wand to place the wand in a user mode;
reading a machine-readable user identity code with said wand optical reading means;
storing said user identity code in said transaction file;
activating product mode switch means on the wand to place the wand in a product mode;
reading a machine-readable product code from said catalog with said wand optical reading means;
storing said product code in said transaction file;
connecting a first connector on the wand second distal end with a mating second connector on the cradle module;
transmitting said transaction file from the wand memory module through the cradle and over the data network to the order center;
receiving a confirmation signal with a printer connected to the cradle module, said confirmation signal sent over the data network from the order center upon receipt of said transaction file;
activating order status mode switch means on the wand to place the wand in an order status mode;
transmitting an order status request from the wand through the cradle over the data network to the order center, said order status request comprising at least said user identity code; and,
receiving an order status response corresponding to said user identity code with said printer connected to the cradle, said order status response sent from the order center over the data network upon receipt of said order status request.

26. A computer program product for conducting automated shopping, the computer program product utilizing a data network and an order center connected to the data network, the computer program product comprising computer executable instructions stored in a computer readable medium, the computer readable medium embedded in a handheld scanning means, the instructions when executed causing the scanning means to:
read a machine readable vendor code;
store said vendor code in a transaction file held on a memory module within the scanning means;
read a machine readable user identity code;
store said user identity code in said transaction file;
read a machine readable product identity code;
store said product identity code in said transaction file;
connect to the data network; and,
transmit said transaction file over the data network to the order center.

27. A computer program product as defined by claim 26 wherein the computer program product further utilizes a cradle module connected to the data network, the cradle module for connection to the scanning means, and wherein said computer program instructions when executed cause said scanning means to transmit said transaction file through the cradle to the order center.

28. A computer program product as defined by claim 27 wherein the scanning means comprise an elongated handheld wand having two distal ends with optical reading means contained in a first distal end and a connector for connecting to the cradle module on the second distal end.

29. A computer program product as defined by claim 26 wherein the computer executable instructions when executed further cause the scanning means to:
enter into a vendor mode upon activation of a vendor mode switch means on the scanning means prior to reading said vendor identity code;
enter into a user mode upon activation of a user mode switch means on the scanning means prior to reading said user identity code;
enter into a product mode upon activation of a product mode switch on the scanning means prior to reading said product identity code; and,
enter into an order mode upon activation of an order mode switch means prior to transmitting said transaction file over the data network to the order center.

30. A computer program product for conducting automated shopping, the computer program product utilizing a catalog, a data network, a cradle module connected to the data network, a peripheral device connected to the cradle module, and an order center connected to the data network, the computer program product comprising computer executable instructions stored in a computer readable medium, the computer readable medium embedded in a handheld wand having a scanning means and a memory module, the instructions when executed causing the wand to:
enter into a vendor mode upon activation of a vendor mode switch means on the wand;
read a machine readable vendor code from the catalog using the optical reader while in said vendor mode;
store said vendor code in a transaction file held on the wand memory module;
enter into a user mode upon activation of a user mode switch means on the wand;
read a machine readable user identity code from the catalog while in said user mode;
store said user identity code in said transaction file;
enter into a product mode upon activation of a product mode switch means on the wand;
read a machine readable product identity code from the catalog while in said product mode;
store said product identity code in said transaction file;
enter into an order mode upon activation of an order mode switch means;
connect to the data network through the cradle module;
transmit said transaction file over the data network to the order center while in said order mode;
accept a confirmation signal transmitted over the data network from the order center; and,
output said confirmation signal over the peripheral device.
